(19) United States
(12) Patent Application Publication
(10) Pub. No.: US 2007/0051174 A1
(43) Pub. Date: Mar. 8, 2007

(54) Predicting temperature induced length variations in structural cords

(75) Inventors: David Vail, West Melbourne, FL (US); David Lenzi, Melbourne, FL (US); Stephen S. Wilson, Melbourne, FL (US)

Correspondence Address: SACCO & ASSOCIATES, PA, P.O. BOX 30999, PALM BEACH GARDENS, FL, 33420-0999, US

(73) Assignee: Harris Corporation, Melbourne, FL (US)

(21) Appl. No.: 11/219,446

(22) Filed: Sep. 2, 2005

(51) Int. Cl. G01F 23/00

(52) U.S. Cl. 73/295

(57) ABSTRACT

Method for predicting an average temperature of a conductive structural component (204) over an elongated length of the structural component. The method can include measuring (406) an electrical resistance of the structural component (204) between two locations (206, 208) spaced apart from each other. The method can also include predicting (408) an average temperature of the structural component (202) between the two locations based on the measuring step. Using the information gained in this step, a dimensional characteristic of the structural component (202) can be predicted (410) based on the average temperature.

### BACKGROUND OF THE INVENTION

1. Statement of the Technical Field

The inventive arrangements relate to structures, and more particularly to methods and systems for determining the temperature of structural elements and the resulting changes to structures from temperature variations.

2. Description of the Related Art

Temperature variations in the environment are known to effect dimensional characteristics of deployed structures. While these dimensional variations can be relatively unimportant in some instances, they can have a significant effect on the performance of certain types of precision structures. This is especially true for space based deployable structures.

Space based deployable structures are especially vulnerable to dimensional variations associated with temperature changes. One reason is that such structures are often exposed to solar heating and other effects that change the temperature of the structural elements tremendously. The mechanical effects of such heating are often difficult to predict with a high degree of precision because different portions of the space deployed structure can be exposed to varying degrees of solar heating. The result is that different portion of a space structure can have very different temperatures. Another reason for this vulnerability is the relative inaccessibility of these structures. In general, it is difficult and expensive to make mechanical adjustments to space deployable structures after they have been launched into space.

Space deployed antennas can be particularly vulnerable to dimensional variations resulting from environmental temperature changes. In order to ensure peak performance, such antennas must be sized and shaped with a high degree of precision. Many types of space deployable antennas are assembled using pre-tensioned graphite cords. These long, thin cords are subject to wide variations in temperature, resulting in length variations. These length variations can distort the antenna shape, thereby degrading RF performance.

It is conceivable that compensation systems could be incorporated into deployed structures to compensate for temperature based dimensional variations of structural elements. For example, in the case of space deployed antennas, RF performance could potentially be enhanced. However, in order for such systems to operate effectively, it would be desirable to have accurate information relating to the temperature of the structural element. The temperature information for each structural component can be very useful for estimating the dimensional variation affecting that structural element.

The accepted method for determining structural component temperature usually involves the use of thermistor based sensors, a traditional sensor interface, and A/D converters. Since wide variations in temperature can occur between different portions of a single structural element, thermistor sensors are usually located at several different locations on each structural component.

Still, there are a number of difficulties associated with the use of thermistors, especially when they are used on tiny graphite cords. For example, distorted temperature readings can result from heating of the thermistor body (as compared to the temperature of the cord). Power dissipation will also occur in the thermistor, causing heating effects. Different areas of the cord are also generally at very different temperatures. The solution for achieving accurate measurement potentially requires many more thermistors than practically possible. Lastly, the use of many thermistors creates a significant potential for snagging during the deployment process as cords are extended and moved into their operating position.

### SUMMARY OF THE INVENTION

The invention concerns a method for identifying a temperature induced dimensional variation in a remotely deployed structure. The method can include measuring an electrical resistance of a structural element of the deployed structure between two locations spaced apart from each other. Thereafter, the method can include predicting a dimensional characteristic of the structural element based on the measuring step. The dimensional characteristic can be a physical dimension of the structural component, such as a length or a width. Alternatively, the dimensional characteristic can be a relative change in a physical dimension of the structural component. In either case, the method can also include the step of controlling at least one variable portion of the structure in order to compensate for a temperature induced variation of the dimension characteristic.

The structural element can be selected to include any portion of a structure for which a dimensional characteristic is to be monitored or measured. For example, the structural element can be a cord. The material from which the cord is formed can be any material that exhibits useful variations in resistance as a function of temperature. For example, the method can be used with graphite cords that are commonly used in remotely deployed space structures. The method can further include selecting the structure to be an antenna structure.

According to another aspect, the invention can consist of a method for predicting temperature induced dimensional variations in structural cords in a deployable structure. For example, the structure could be an antenna and the cord could be formed of a material such as graphite. The method can begin by forming a structure that includes a plurality of cords. The electrical resistance of one or more cords in the structure can be measured to obtain information concerning their baseline resistance values at one or more known temperatures. Thereafter, the method can include predicting a dimension or a change in dimension of the cord based on the measuring step. The method can also include the step of deploying the structure to a remote environment. Thereafter, the electrical resistance of the cord can be monitored. The monitoring can allow prediction, in the remote environment, of a resulting dimension of the cord at various temperatures, or a temperature induced change of the cord dimension. Finally, the method can also include controlling at least one variable portion of the structure to compensate for the temperature induced variation of the dimension.

Viewed from a broader aspect, the method can include a process that is useful for measuring a dimensional characteristic of a structural component. In this regard, the invention can include forming an electrical connection with the structural component at two predetermined locations spaced apart from one another. Thereafter, the method can include measuring an electrical resistance of the structural component between the locations. Finally, a dimensional characteristic of the structural component can be determined based on an electrical resistance value obtained from the measuring step. The structural component can also be subjected to an environment which causes a temperature of the structural component to vary over a period of time. In that case, the value of the dimensional characteristic can be periodically determined as the temperature is varied.

The dimensional characteristic can be a physical dimension of the structural component, such as a length or a width. Alternatively, the dimensional characteristic can be a relative change in a physical dimension of the structural component. In either case, the method can also include referring to a look-up-table to cross-reference the electrical resistance value that has been measured to a predetermined dimensional characteristic of the structural component. Alternatively, or in addition to the look-up step, the determining step can include calculating the dimensional characteristic of the structural component based on a change in the electrical resistance value that has been measured.

The method can also include a calibration step. The calibration step can include measuring an electrical resistance and a dimensional characteristic of the structural component over a predetermined temperature range. Using the foregoing information, a look-up table can be generated. For example, the look-up table can relate an electrical resistance of the structural element to a dimensional characteristic of the structural component. The calibration step can occur at a pre-determined temperature or over a range of temperatures. Subsequently, the measured resistance values at various environmental temperatures can be used to predict a dimension of a structural element or a change in dimension.

According to another aspect, the invention can include a method for predicting an average temperature of a conductive structural component over an elongated length of the structural component. The method can include measuring an electrical resistance of the structural component between two locations spaced apart from each other. Finally, an average temperature of the structural component between the two locations can be predicted based on the measuring step. Using the information gained in this step, a dimensional characteristic of the structural component can be predicted based on the average temperature. For example, the dimensional characteristic can be selected from the group consisting of a length, a width, a change in length, and a change in width. According to one embodiment, the structural element can be a graphite cord. Further, the graphite cord can be included in a deployable structure prior to the measuring and predicting steps.

According to yet another aspect, the method can include identifying a temperature induced dimensional variation in a remotely deployed structure. In this instance, the method can include measuring an electrical resistance of two or more structural elements of the deployed structure between two locations spaced apart from each other on each structural element. Based on this measuring step, the method can continue by predicting a dimensional characteristic of each of the structural elements that have been measured. Using this information, the overall effect of the temperature variation on the structure can be determined. Finally, the method can include automatically compensating for the measured variations throughout the structure. The compensation process can include mechanical adjustments to the structure. Alternatively, the compensation process can involve electrically compensating for the change in the overall structure.

### BRIEF DESCRIPTION OF THE DRAWINGS

FIG. 1 is a drawing of a deployable structure that is useful for understanding the invention.

FIG. 2 is a drawing of a portion of a deployable structure that is useful for understanding the invention.

FIG. 3 is a plot that is useful for understanding the relationship between temperature and resistance for a structural element.

FIG. 4 is a flow chart that is useful for understanding a method for predicting temperature-induced length variations in structural elements of a deployed structure.

FIG. 5 is a block diagram showing a measuring step for determining a dimensional characteristic of a structural element.

FIG. 6 is an example of a control system that is useful for understanding the present invention.

### DETAILED DESCRIPTION OF THE PREFERRED EMBODIMENTS

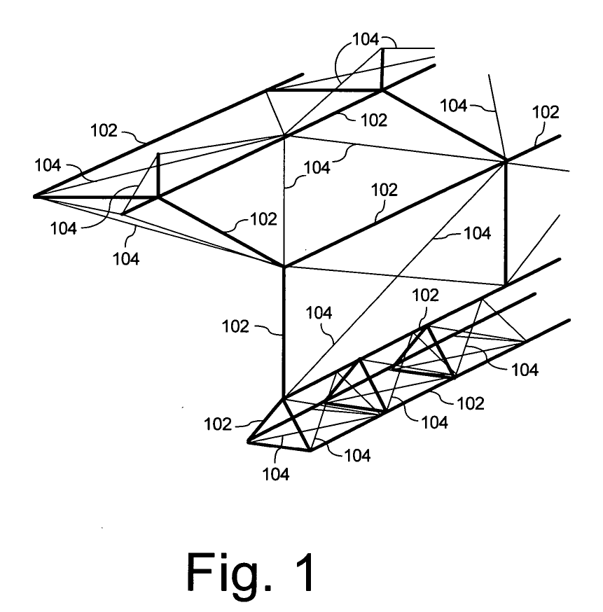

An example of a portion of a space-based deployable structure 100 is illustrated in FIG. 1. The structure 100 can be part of a sensor array, antenna system, solar panel array, solar sail, telescope, or any other useful structure that may be deployed. Space deployable structures, such as structure 100, are typically formed from a variety of lightweight structural elements. These structural elements can include rigid structural elements 102 as well as flexible tapes and cords 104. Some of these structural elements are formed of lightweight materials such as graphite and graphite composite.

Solar heating and other effects in a space environment can have a dramatic effect on the temperature of the various structural elements 102, 104. In fact, the temperature of a structural element can even vary widely from one portion of the structural element to another. For example, this can occur when a portion of the structural element is exposed to sunlight and another portion is shaded from the sun.

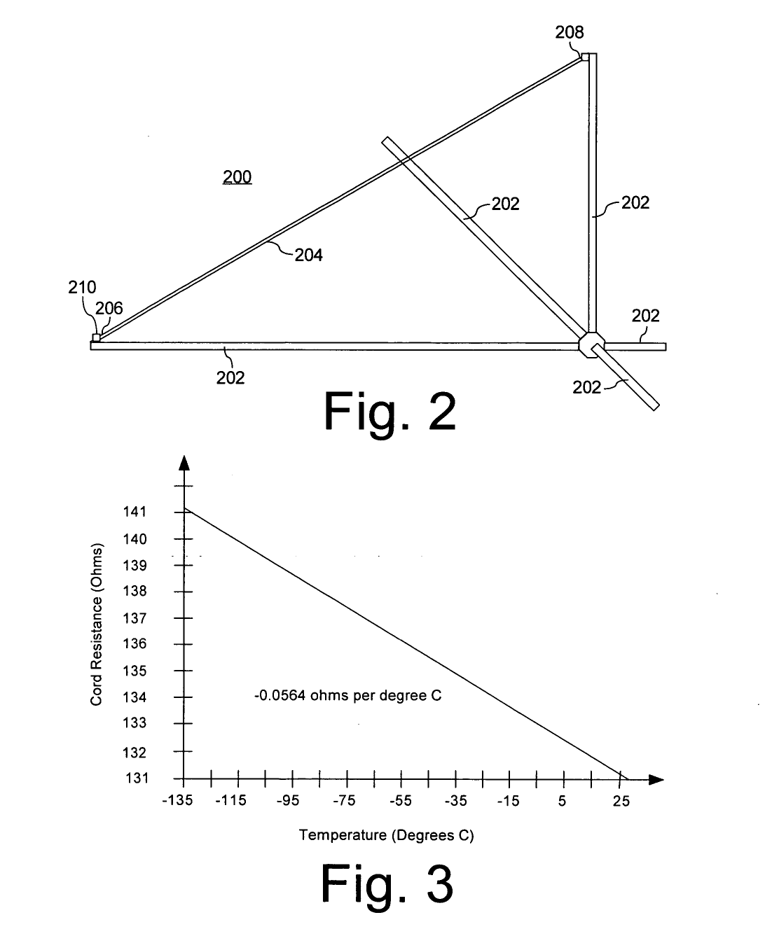

Referring now to FIG. 2, there is shown a portion of a space deployable structure 200 that include rigid structural elements 202 and a flexible structural element 204. When portions of the structure 200 are exposed to changes in temperature, such variations can result in dimensional changes to the structural elements. Such dimensional changes are particularly noticeable in the case of long structural elements where the resulting dimensional changes over the entire length of the element can dramatically affect the overall length. These dimensional variations are problematic because they can distort the overall geometry of the structure. These distortions can have a negative impact on the strength, rigidity or performance of the structure. For example, in the case of antenna structures, the dimensional changes can affect the shape and/or size of mesh reflector surfaces. These changes can result in degraded RF performance.

The present invention provides a method for determining a temperature induced dimensional variation in a remotely deployed structure. In general, the method can include measuring an electrical resistance of a structural element 102, 104 of a deployed structure 200 between two locations 206, 208 on the structural element that are spaced apart from each other. For example, the two locations can be opposing ends of the structural element. Depending on the particular material of the structural element, the electrical resistance value between the two locations will change as a function of temperature. If resistance values corresponding to different temperatures are known in advance, then a temperature of the structural component can be predicted. If the temperature of the structural component can be determined in this way, then a dimensional characteristic of the element can be predicted by computational means or otherwise.

Specifically, the foregoing prediction can be accomplished by utilizing known data regarding the expansion and contraction characteristics of materials and/or specific structural components as a function of temperature. Thus, for a given change in temperature, a dimensional characteristic of the structural component can be determined. In this regard, it should be noted that the term dimensional characteristic as used herein can mean a physical dimension of the structural component, such as a length or a width. However, the term dimensional characteristic can also refer to a relative change in a physical dimension of the structural component.

In order to more fully understand the foregoing technique, it is useful to refer to the plot shown in FIG. 3. The plot in FIG. 3 shows how the resistance of a structural element changes with temperature. The plot in FIG. 3 shows the measured end to end resistance of a graphite cord about 18 feet in length over a temperature range from −135° C. to +25° C.. It can be observed that the end to end resistance of the cord varies from about 131 ohms to about 141 ohms over this temperature range. Thus, it will be understood that the temperature of the cord can be predicted from the measured resistance. For example, if the measured resistance is 136 ohms, one can predict that the average temperature of the graphite cord is about −55° C.. In the same way, the temperature of other types of structural elements can also be predicted, provided that the resistance between two points on the structural element is known to vary as a function of temperature. This temperature information can be used to calculate a dimensional characteristic of the cord at that temperature.

An advantage of the inventive arrangements is that measurement of cord resistance reports the true average temperature of the cord. In contrast, the prior art uses thermistors to report temperatures at discrete points on the cord. Testing has confirmed that graphite cord resistance varies as a result of temperature changes, and not due to changes in cord tension or other reasons. Also, the graphite cord resistance value does not affect the rate of change of resistance versus cord temperature. Further, it has been found that there is minimal hysteresis in the measured cord resistance as a function of temperature. Accordingly, the resistance at a given temperature tends to remain the same regardless of whether the cord is arriving at a given temperature after being heated or cooled.

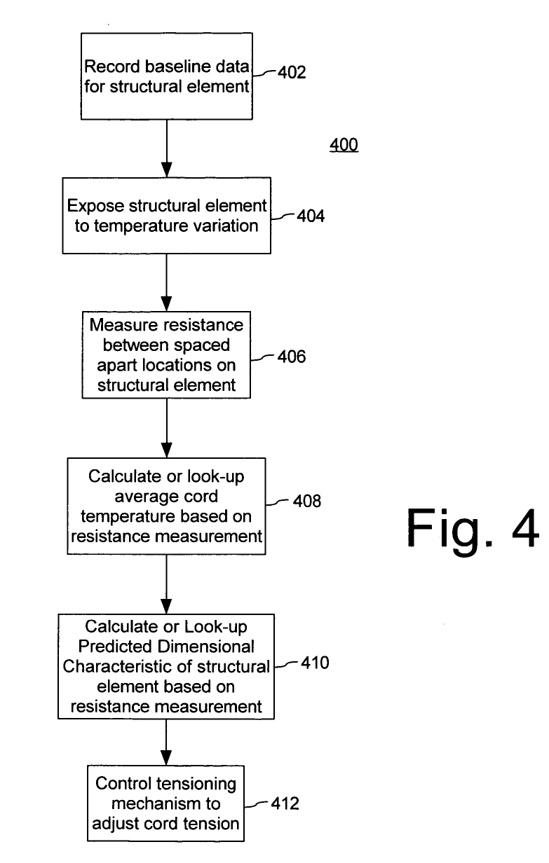

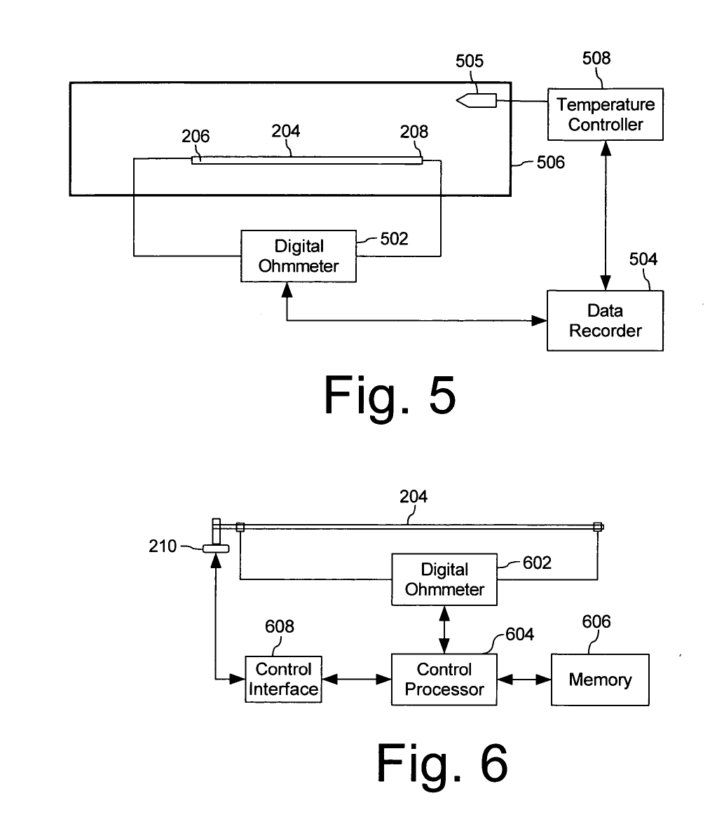

Referring now to FIG. 4, a flowchart 400 is provided that is useful for understanding a series of steps that can be followed to implement a method in accordance with the inventive arrangements. The method can begin in step 402 by recording certain baseline data relating to a structural element 202, 204. The specific implementation of this step can vary to some extent depending on the degree of accuracy that is required for a particular application. For a particular structural element 202 of known dimension, this step can include a resistance measurement at a predetermined temperature between two spaced apart locations 206, 208 on the structural element. This measured data can be used in combination with information regarding the typical resistance change per degree C. of a particular material to thereafter compute a temperature of the structural component. For example, if structural element 202 is a graphite cord, then it can be determined from the data in FIG. 5 that the resistance change per degree C. is −0.0564 ohms per degree C.. Therefore a measured change in resistance of 9 ohms would indicate a temperature change of about 159° C..

For greater accuracy, the resistance between two points of a structural element can be measured at a plurality of temperatures to obtain a number of data points specific to that structural element. Thereafter, specific resistance measurements can be directly related to the temperature of the structural element. For example, in the example shown in FIG. 3, a specific measured resistance of 136 ohms could be related to a temperature of −55° C.. Interpolation techniques or other similar processes can be used to determine temperature values between data points. The resistance measurements can be recorded in a look-up table or can be characterized in a mathematical equation.

FIG. 5 shows a test jig that can be used to measure resistance of structural element 204. For this measurement, it can be advantageous to use a digital ohmmeter 502. The resistance data at one or more temperatures can be collected manually or by automated means. For example, the digital ohmmeter can be connected by way of a digital interface to a data recorder 504. Data recorder 504 can be a dedicated data collection device or a computer that is programmed to record data at periodic intervals or predetermined temperatures. The structural element 204 can be disposed within a temperature chamber 506 so that it is exposed to varying temperature conditions. The temperature within the temperature chamber 506 can be controlled by means of a thermocouple 505 and a temperature controller 508. If desired, temperature data can be automatically transferred from the temperature controller 508 to the data recorder 504.

After the baseline data for the structural component or components has been collected in step 402, the structural element, can be deployed to a remote environment. For example, the structural element 204 can be incorporated into a space deployable structure 200 and launched into space. Thereafter, in step 404, a temperature variation can be induced into the structural element. The temperature variation can occur as a result of solar heating or from other factors present in the environment. In any case, a temperature change can occur in all or part of the structural element.

Thereafter, in step 406, the resistance between the two spaced apart locations 206, 208 on the structural element 204 can be measured in the deployed environment. Based on the resistance value measured in step 406, a temperature of the structural element 204 can be determined in step 408. The temperature can be calculated based on the measured resistance value from step 406, the known baseline resistance value at a predetermined temperature from step 402, and the typical resistance change per degree C. for the element 204. Alternatively, a look-up-table can be used to relate specific measured resistance values to corresponding temperatures as previously measured for structural element 204 under baseline test conditions in step 402. Regardless of the technique used to determine the temperature of the structural element 204, the temperature information can thereafter be used in step 410 to determine a dimensional characteristic of the structural element corresponding to a particular temperature or change in temperature relative to a baseline value.

As an alternative to first determining a temperature of the structural component, those skilled in the art will appreciate that a look-up-table can be provided which directly relates a resistance value to a dimensional characteristic of the structural element. Thus, the temperature determining step can be avoided if the dimensional characteristic data corresponding to specific temperatures is pre-calculated (e.g. prior to deployment) and has been already related to specific electrical resistance measurements in a look-up table. It should be understood that the invention is not intended to be limited to any particular method for determining dimensional characteristics of the structural components from the measured resistance data. Instead, all such methods are intended to be within the scope of the present invention.

Regardless of how the dimensional characteristic is determined in step 410, the method can include a further step of controlling at least one variable portion of the structure 200 in order to compensate for a temperature induced variation of the dimension characteristic. For example, if the structural component is a cord, then an adjusting device can be provided at one or both ends of the structural component. In FIG. 2, a cord adjustment mechanism 210 can be provided for increasing or decreasing the effective length of the cord between opposing end points where it is attached to the structure 200. The adjustment mechanism can be any device capable of adjusting the effective length of the cord 204 in response to a control signal. For example, the adjustment mechanism can include a motor that rotates a drum upon which a portion of the cord 204 is anchored. Rotating the drum can increase or decrease the tension on the cord a predetermined amount. Of course, this is merely one example of how the effective length of the cord could be adjusted and the invention is not limited in this regard. Numerous other methods are also possible, and the invention is not intended to be limited to any particular type of adjustment mechanism.

The foregoing step involves an electromechanical arrangement for physically controlling a variable portion of the structure. When the cord changes length, an adjustment mechanism 210 directly compensates to correct for that change. However, in some instances, the changes in dimensional characteristics of the structure can have effects that are of concern primarily because they alter the electrical or RF properties of the structure. This would be the case, for example, where the structure is a deployed antenna. In such instances, an alternative approach to correcting for the physical change could be a signal processing change. For example, the information relating to the change in physical dimension could be provided to a signal processing computer. The signal processing computer could implement a phase compensation algorithm to correct for the physical distortion in the antenna. Such an arrangement would be particularly useful in a phased array antenna or phased array fed reflector or lens antenna. With this approach, the mechanical deformation is not necessarily “corrected”. Instead, the physical deformation is only determined, measured, and compensated for electrically without making any actual physical geometry changes in the structure.

Referring to FIG. 6, a suitable control system for controlling the adjustment mechanism 210 is shown. The control system can include a digital ohmmeter 602, a controller or microprocessor 604 with suitable memory 606 or other data storage capability, and control interface circuitry 608 for interfacing with the cord adjustment mechanism 210. The microprocessor 604 can be programmed to calculate dimensional characteristics of a structural element 204, determine a corrective action to achieve a desired effective length of the structural element 204 to compensate for a temperature change, and can operate the adjustment mechanism 210 accordingly.

As noted above, different portions of a structural element can be at very different temperatures, particularly in a space environment. In this regard, it should be noted that the temperature determined using the techniques and methods described herein will generally be an average temperature of the structural element between the two points at which resistance is measured. This averaging effect can be highly advantageous as it is more likely to permit a more accurate calculation of a temperature induced variation in a dimensional characteristic of the structural element as compared to discrete thermistor measurement techniques.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

We claim:

1. A method for determining a dimensional characteristic of a structural component, comprising:
forming an electrical connection with said structural component at two predetermined locations spaced apart from one another;
measuring an electrical resistance of said structural component between said locations; and
determining a dimensional characteristic of said structural component based on an electrical resistance value obtained from said measuring step.

2. The method according to claim 1, further comprising, determining a temperature of said structural component based on said electrical resistance value.

3. The method according to claim 1, further comprising, automatically compensating for a change in said dimensional characteristic over a period of time.

4. The method according to claim 3, wherein said compensating step comprises a mechanical adjustment of said structural component.

5. The method according to claim 3, wherein said compensating step comprises an electrical adjustment to electronically compensate for said change in said dimensional characteristic.

6. The method according to claim 1, further comprising selecting said dimensional characteristic to be a length of said structural component.

7. The method according to claim 1, wherein said determining step comprises referring to a look-up-table to cross-reference said electrical resistance value that has been measured to a predetermined dimensional characteristic of said structural component.

8. The method according to claim 1, wherein said determining step comprises calculating said dimensional characteristic based on a change in said electrical resistance value that has been measured.

9. The method according to claim 1, wherein said determining step further comprises a calibration step.

10. The method according to claim 9, wherein said calibration step includes measuring an electrical resistance of said structural component at a predetermined set of data points over a predetermined temperature range.

11. The method according to claim 10, further comprising generating a look up table based on said calibration step that relates an electrical resistance of said structural element to a dimensional characteristic of said structural component.

12. The method according to claim 9, wherein said calibration step further comprises measuring a resistance of said structural element at a predetermined temperature.

13. A method for predicting temperature induced dimensional variations in structural cords in a deployable structure by measuring electrical resistance, comprising:
forming a structure that includes a plurality of cords;
measuring an electrical resistance of a cord in said structure;
predicting at least one dimensional characteristic of said cord selected from the group consisting of a dimension of said cord and a change in dimension of said cord based on said measuring step.

14. The method according to claim 13, further comprising determining a temperature of said cord based on said measuring step.

15. The method according to claim 13, further comprising controlling at least one variable portion of said structure to compensate for said change in dimension.

16. The method according to claim 13, further comprising electronically compensating for said change in dimension of said cord.

17. The method according to claim 13, further comprising selecting a material of said cord to be graphite.

18. A method for identifying a temperature induced dimensional variation in a remotely deployed structure, comprising:
measuring an electrical resistance of a structural element of said deployed structure between two locations spaced apart from each other on said structural element;
predicting a dimensional characteristic of said structural element based on said measuring step.

19. The method according to claim 18, further comprising selecting said structural element to be a cord.

20. The method according to claim 19, further comprising selecting a material from which said cord is formed to be graphite.

21. The method according to claim 18, further comprising determining a temperature of said cord based on said measuring step.

22. The method according to claim 18, further comprising selecting said dimensional characteristic from the group consisting of a change in a length of said structural element and an actual length of said structural element.

23. The method according to claim 18, further comprising controlling at least one variable portion of said structure to compensate for a temperature induced variation of said dimension characteristic.

24. The method according to claim 18, further comprising electronically compensating for a temperature induced variation of said dimension characteristic.

25. A method for determining an average temperature of a conductive structural component over an elongated length of the structural component, comprising:
measuring an electrical resistance of said structural element between two locations spaced apart from each other;
predicting an average temperature of said structural element between said two locations based on said measuring step.

26. The method according to claim 25, further comprising predicting a dimensional characteristic of said structural component based on said average temperature.

27. The method according to claim 26, further comprising selecting said dimensional characteristic from the group consisting of a length, a width, a change in length, and a change in width.

28. The method according to claim 25, further comprising selecting said structural element to be a graphite cord.

29. The method according to claim 28, further comprising integrating said graphite cord in a deployable structure prior to said measuring and predicting steps.

30. A method for identifying a temperature induced dimensional variation in a remotely deployed structure, comprising:
measuring an electrical resistance of a plurality of structural elements of said deployed structure between two locations spaced apart from each other on each said structural element;
predicting a dimensional characteristic of each said structural element based on said measuring step; and
automatically compensating for a variation of said dimension characteristic.

31. The method according to claim 30, further comprising selecting said plurality of structural elements to be cords.

32. The method according to claim 31, further comprising selecting a material from which said cords are formed to be graphite.

33. The method according to claim 30, further comprising determining a temperature of said plurality of cords based on said measuring step.

34. The method according to claim 30, further comprising selecting said dimensional characteristic from the group consisting of a change in a length of said structural elements and an actual length of said structural elements.

35. The method according to claim 30, wherein said compensating step further comprises controlling at least one variable portion of said structure to compensate for a variation of said dimension characteristic.

36. The method according to claim 30, wherein said compensating step further comprises electronically compensating for said variation of said dimensional characteristic.
